(19) United States
(12) Patent Application Publication
(10) Pub. No.: US 2007/0236434 A1
(43) Pub. Date: Oct. 11, 2007

(54) Display drive device and liquid crystal display device

(75) Inventor: Tooru Arai, Kanagawa-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/730,281

(22) Filed: Mar. 30, 2007

(30) Foreign Application Priority Data
Apr. 6, 2006 (JP) P2006-105742

(51) Int. Cl. G09G 3/36

(52) U.S. Cl. 345/87

(57) ABSTRACT

A display drive device includes a plurality of cascade connected source drivers, each having a pixel data input circuit for receiving and outputting a pixel data, a clock input circuit for receiving a clock signal for latching a pixel data outputted from the pixel data input circuit, a latch circuit for latching the pixel data outputted from the pixel data input circuit in synchronization with the clock signal, a data output circuit for outputting the pixel data inputted to the clock input circuit, a clock output circuit outputting the clock signal inputted to the clock input circuit, a generation circuit generating a data take-in signal for instructing the source driver to start to drive, and a detector for latching a start pulse signal providing a display timing or the data take-in signal outputted from the generation circuit in synchronization with the clock signal; and a controller for controlling start of drive of the clock output circuit or the pixel data output circuit of the first source driver by the time the data take-in signal is outputted from the generation circuit from a time when the first source driver starts to latch the pixel data.

### CROSS REFERENCE TO THE RELATED APPLICATION

This application is based upon and claims the benefit of priority from the prior Japanese Application No. 2006-105742, filed Apr. 6, 2006, the entire contents of which are incorporated by reference herein.

### BACKGROUND OF THE INVENTION

1. Field of the Invention

This invention relates to display drive device and liquid crystal display device. More particularly, the invention pertains to a display drive device and a liquid crystal display device having cascade connection.

2. Description of the Related Art

A signal line of a liquid crystal display can be driven using a source driver. Since the number of the signal lines which can be driven by one source driver is limited, usually a cascade connection is made of two or more source drivers, which drive all signal lines. In order that source drivers are constituted by a cascade connection, the data lines go through the source driver. When obtaining bigger images or higher resolution images, it will be necessary to increase the frame size of a liquid crystal panel. For this reason, COG (Chip On Glass) mounting technology is proposed, which eliminates the need for a printed circuit board.

However, in this conventional source driver, although an internal latch and an internal shift register operate during the sampling, a clock input circuit, a clock output circuit, a data input circuit, and a data output circuit constantly operate to transmit data to the following source driver. Therefore, there is a problem that the power consumption and electromagnetic interference (EMI) of the source driver increase by operation of these circuits. Especially, as the number of source drivers increases by increase of the number of signal lines accompanying high integration and high resolution in recent years, the power consumption and EMI of a source driver increases further.

### SUMMARY OF THE INVENTION

One or more of the problems outlined above may be addressed by embodiments of the invention. Broadly speaking, systems and methods are provided to derive information identifying the power usage characteristics of software programs, and the information is used to determine the manner in which the software programs will be executed, thereby improving the management of power within the device executing the programs.

A display drive device according to an aspect of the present invention includes a plurality of cascade connected source drivers, each source driver including a pixel data input circuit for receiving and outputting a pixel data, a clock input circuit for receiving a clock signal for latching a pixel data outputted from the pixel data input circuit, a latch circuit for latching the pixel data outputted from the pixel data input circuit in synchronization with the clock signal, a data output circuit for outputting the pixel data inputted to the clock input circuit, a clock output circuit outputting the clock signal inputted to the clock input circuit, a generation circuit generating a data take-in signal for instructing the source driver to start to drive, and a detector for latching a start pulse signal providing a display timing or the data take-in signal outputted from the generation circuit in synchronization with the clock signal; and a controller for controlling start of drive of the clock input circuit or the pixel data input circuit of the first cascade connected source driver by the time the start pulse signal is inputted, the controller starting to drive the clock input circuit or the pixel data input circuit of a source driver other than the first source driver by the time the data take-in signal is inputted to the source driver other than the first source driver from a time when the first source driver starts to latch the pixel data.

A display drive device according to another aspect of the present invention includes a plurality of cascade connected source drivers, each source driver including a pixel data input circuit for receiving and outputting a pixel data, a clock input circuit for receiving a clock signal for latching a pixel data outputted from the pixel data input circuit, a latch circuit for latching the pixel data outputted from the pixel data input circuit in synchronization with the clock signal, a data output circuit for outputting the pixel data inputted to the clock input circuit, a clock output circuit outputting the clock signal inputted to the clock input circuit, a generation circuit generating a data take-in signal for instructing the source driver to start to drive, and a detector for latching a start pulse signal providing a display timing or the data take-in signal outputted from the generation circuit in synchronization with the clock signal; and a controller for controlling start of drive of the clock output circuit or the pixel data output circuit of the first source driven by the time the data take-in signal is outputted from the generation circuit from a time when the first source driver starts to latch the pixel data.

A liquid crystal display device according to an aspect of the present invention includes a liquid crystal display; and a plurality of cascade connected source drivers coupled to the liquid crystal display, each source driver including a pixel data input circuit for receiving and outputting a pixel data, a clock input circuit for receiving a clock signal for latching a pixel data outputted from the pixel data input circuit, a latch circuit for latching the pixel data outputted from the pixel data input circuit in synchronization with the clock signal, a data output circuit for outputting the pixel data inputted to the clock input circuit, a clock output circuit outputting the clock signal inputted to the clock input circuit, a generation circuit generating a data take-in signal instructing the source driver to start to drive, and a detector for latching a start pulse signal providing a display timing or the data take-in signal outputted from the generation circuit in synchronization with the clock signal; and a controller for controlling start of drive of the clock input circuit or the pixel data input circuit of the first cascade connected source driver by the time the start pulse signal is inputted, the controller starting to drive the clock input circuit or the pixel data input circuit of a source driver other than the first source driver by the time the data take-in signal is inputted to the source driver other than the first source driver from a time when the first source driver starts to latch the pixel data.

A liquid crystal display device according to another aspect of the present invention includes a liquid crystal display; and a plurality of cascade connected source drivers coupled to the liquid crystal display, each source driver including a pixel data input circuit for receiving and outputting a pixel data, a clock input circuit for receiving a clock signal for latching a pixel data outputted from the pixel data input circuit, a latch circuit for latching the pixel data outputted from the pixel data input circuit in synchronization with the clock signal, a data output circuit for outputting the pixel data inputted to the clock input circuit, a clock output circuit outputting the clock signal inputted to the clock input circuit, a generation circuit generating a data take-in signal instructing the source driver to start to drive, a detector for latching a start pulse signal providing a display timing or the data take-in signal outputted from the generation circuit in synchronization with the clock signal; and a controller for controlling start of drive of the clock output circuit or the pixel data output circuit of the first source driver by the time the data take-in signal is outputted from the generation circuit from a time when the first source driver starts to latch the pixel data.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a block diagram showing an example of the internal configuration of a liquid crystal drive device according to a first embodiment of this invention.

FIG. 2 is a block diagram showing an example of the internal configuration of source drivers IC1-ICn according to a first embodiment of this invention.

FIG. 3A is a circuit diagram showing an example of the configuration of 1st control circuit 17 in the control circuit 11 of the source drivers IC1-ICn according to a first embodiment of this invention.

FIG. 3B is a circuit diagram showing an example of the configuration of 2nd control circuit 18 in the control circuit 11 of the source drivers IC1-ICn according to a first embodiment of this invention.

FIG. 3C is a circuit diagram showing an example of the configuration of 3rd control circuit 19 in the control circuit 11 of the source drivers IC1-ICn according to a first embodiment of this invention.

FIG. 4A is a circuit diagram showing an example of the configuration of a sampling circuit 16 in the control circuit 11 according to a first embodiment of this invention.

FIG. 4B is a circuit diagram showing an example of the configuration of a DOI generation circuit 13 in the control circuit 11 according to a first embodiment of this invention.

FIG. 5A is a truth table of the internal signal of the control circuit 11 of the source drivers IC1-ICn according to a first embodiment of this invention.

FIG. 5B is a truth table of the internal signal of the control circuit 11 of the source drivers IC1-ICn according to a first embodiment of this invention.

FIG. 5C is a truth table of the internal signal of the control circuit 11 of the source drivers IC1-ICn according to a first embodiment of this invention.

FIG. 6A is a truth table of the internal signal of the control circuit 11 of the source drivers IC1-ICn according to a first embodiment of this invention.

FIG. 6B is a truth table of the internal signal of the control circuit 11 of the source drivers IC1-ICn according to a first embodiment of this invention.

FIG. 7 is a circuit diagram showing an example of the configuration of the control circuit 11.

FIG. 8 is a timing chart of a liquid crystal drive device in FIG. 1.

### DETAILED DESCRIPTION OF THE PREFERRED EMBODIMENTS

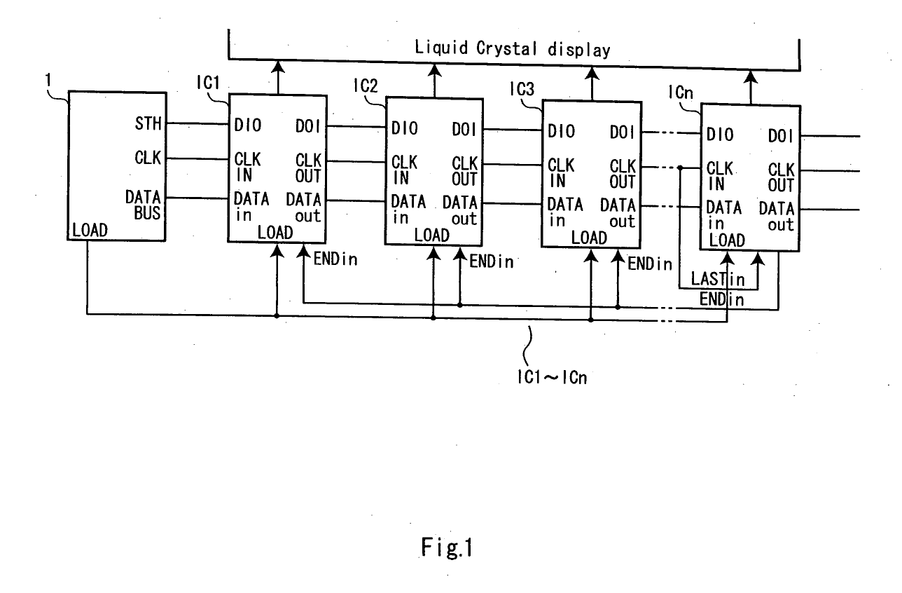

Various other objects, features and attendant advantages of the present invention will be more fully appreciated as the same becomes better understood from the following detailed description when considered in connection with the accompanying drawings in which like reference characters designate like or corresponding parts throughout the several views and more particularly to FIG. 1 thereof.

As shown in FIG. 1, the signal-line drive circuit includes two or more source drivers IC1-ICn by which cascade connection is carried out, and controller 1 which controls source drivers IC1-ICn. Below, cascade connection of source drivers IC1-ICn is described, and an example for which each source driver drives m signal lines is explained.

Controller 1 supplies start pulse signal STH to source driver IC 1. Controller 1 supplies digital pixel data to source driver IC 1 through a data bus, and supplies each digital pixel data DATA to source drivers IC2-ICn via each source drivers IC1-ICn. In addition, controller 1 supplies clock signal CLK to source driver IC 1, and supplies clock signal CLK to source drivers IC2-ICn via each source drivers IC1-ICn. Controller 1 supplies load signal LOAD to each source drivers IC1-ICn.

Each of source drivers IC1-ICn has the same circuit configuration, and drives two or more signal lines. In correspondence with display resolution, the number of source drivers IC1-ICn by which cascade connection is carried out can be adjusted.

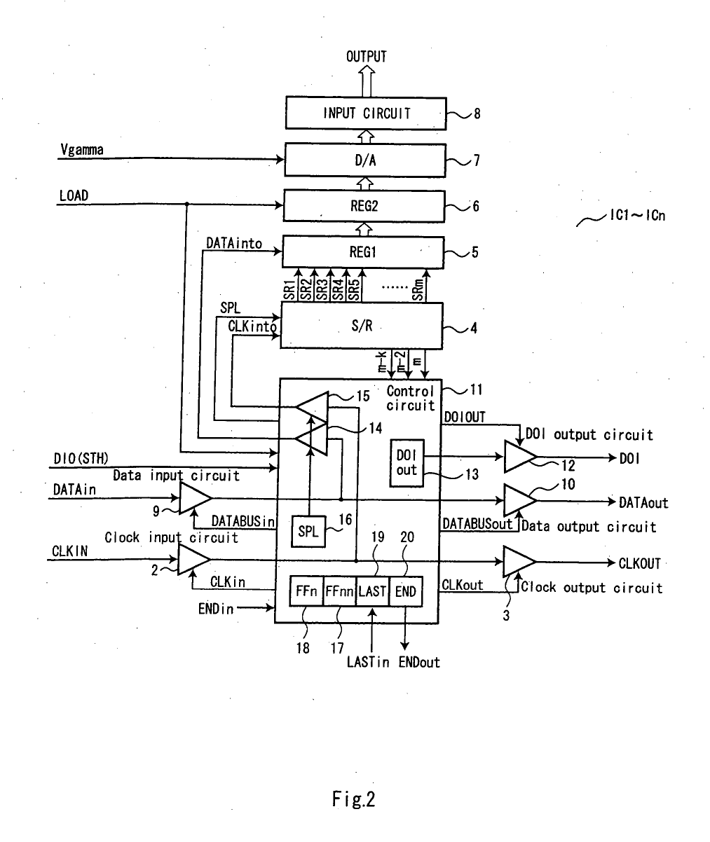

As shown in FIG. 2, source drivers IC1-ICn includes clock input circuit 2 buffering clock signal CLK for a pixel display, clock output circuit 3 which buffers clock signal CLK for outputting clock signal CLK to source drivers IC2-ICn, shift register (S/R) 4 generating two or more shift clocks SR1-SRm which have different phases for the take-in timing of digital pixel data, 1st latch circuit (REG1) 5 which shifts time and latches digital pixel data one by one using shift clocks SR1-SRm, 2nd latch circuit (REG2) 6 latching all latch data simultaneously by the timing of load signal LOAD when source drivers IC1-ICn finish to latch digital pixel data DATA for 1 level line, D/A converter 7 changing the latch data of 2nd latch circuit 6 to an analog pixel voltage, output circuit 8 buffering each analog pixel voltage and supplying each analog pixel voltage to a signal line, pixel data input circuit 9 buffering inputted digital pixel data and supplying inputted digital pixel data to 1st latch circuit 5, pixel data output circuit 10 buffering digital pixel data for outputting digital pixel data to source drivers IC2-ICn, control circuit 11 controlling each circuit, and DOI output circuit 12 buffering data take-in signal DOI generated by the control circuit 11 and transmitting data take-in signal DOI to source driver IC2-ICn.

Output circuit 8 is coupled to a liquid crystal display, and outputs pixel data to the liquid crystal display.

As shown in FIG. 1 and FIG. 2, source drivers IC1-ICn have a DOI terminal for transmitting data take-in signal DOI. FIG. 1 shows the take-in end of digital pixel data to the following source driver, the DIO terminal of source drivers IC2-ICn inputting data take-in signal DOI outputted from the preceding source driver. Start pulse signal STH is inputted to the DIO terminal of the source driver IC 1. Each source driver IC1-ICn starts to drive signal lines by start pulse signal STH or data take-in signal DOI inputted to a DIO terminal. Data take-in signal DOI is generated by DOI generation circuit 13, and is transmitted to source drivers IC2-ICn.

Each source driver IC1-ICn has a data input terminal DATAin for inputting digital pixel data outputted from the controller 1, and a data output terminal DATAout for outputting digital pixel data to source drivers IC2-ICn. Digital pixel data inputted to digital input terminal DATAin branches in control circuit 11. One digital pixel data is outputted to source drivers IC2-ICn through pixel data output circuit 10 from data output terminal DATAout, another digital pixel data is buffered by buffer 14 in a control circuit 11, and digital pixel data DATAinto is inputted to 1st latch circuit 5.

Each source driver IC1-ICn has a clock input terminal CLKIN for inputting clock signal CLK outputted from the controller 1, and a clock output terminal CLKOUT for outputting clock signal CLK to source drivers IC2-ICn. Clock signal CLK inputted to clock input terminal CLKIN branches in control circuit 11 through clock input circuit 2, and one clock input terminal CLKIN is outputted to source drivers IC2-ICn through clock output circuit 3 from clock output terminal CLKOUT, another clock input terminal CLKIN is buffered by buffer 15 in control circuit 11, and clock signal CLKinto is inputted to shift register 4.

Here, buffers 14 and 15 are synchronized with control signal SPL outputted to buffers 14 and 15 from SPL circuit 16 in a control circuit 11. When control signal SPL is active, clock signal CLKinto and digital pixel data DATAinto are outputted.

Control circuit 11 controls to decrease the power consumption of the source drivers IC1-ICn as much as possible. That is, operations of clock input circuit 2 etc are controlled by various control signals outputted from control circuit 11, for example, control signal CLKin inputted to clock input circuit 2, control signal CLKout inputted to clock output circuit 3, control signal DATABUSin inputted to pixel data input circuit 9, control signal DATABUSout inputted to pixel data output circuit 10, control signal DOIOUT inputted to DOI output circuit 12, and control signal ENDout (ENDin) outputted from control circuit 11.

Here, as shown in FIG. 1, control signal ENDout is a control signal outputted from source driver ICn of the last stage, and is inputted to source driver IC1-ICn-1 as control signal ENDin. LASTin signal and data take-in signal DOI from source driver ICn-1, are inputted to source driver ICn of the last stage.

Control circuit 11 has two or more flip-flops FFn, FFnn, LAST, and END.

For example, in 1st embodiment, control part including flip-flop FFn may be a 1st control part 17, control part including flip-flop FFn may be a 2nd control part 18, and control part including flip-flops LAST and END may be 3rd control parts 19 and 20.

1st control part 17, 2nd control part 18, and 3rd control parts 19 and 20 output control signal CLKin to clock input circuit 2 for controlling operations of clock input circuit 2.

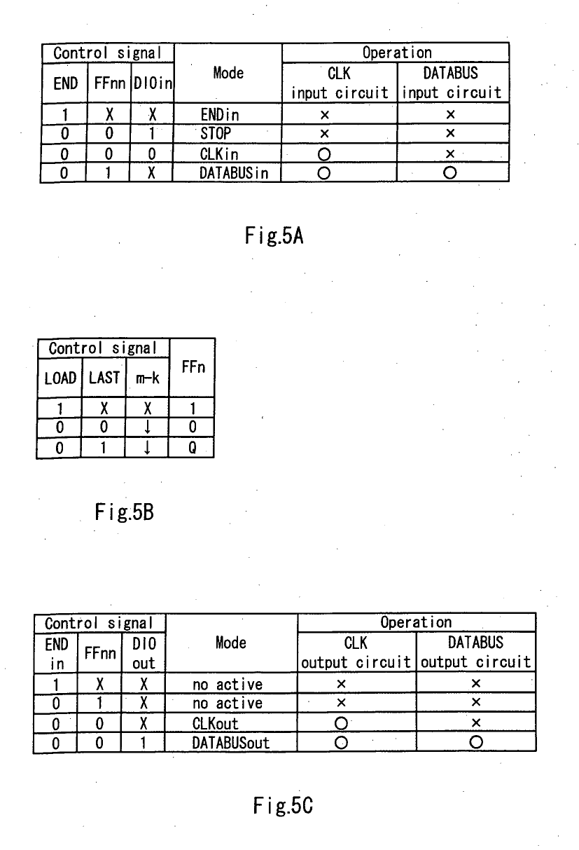

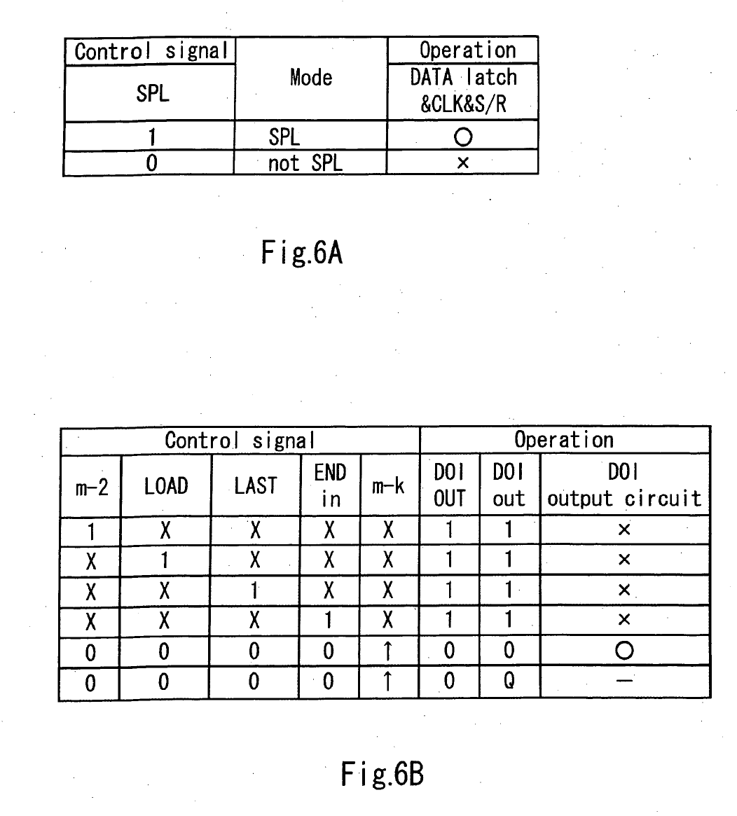

Next, the configuration and operation of control circuit 11 in source drivers IC1-ICn and its operation are explained using the truth value tables of FIGS. 5 and 6.

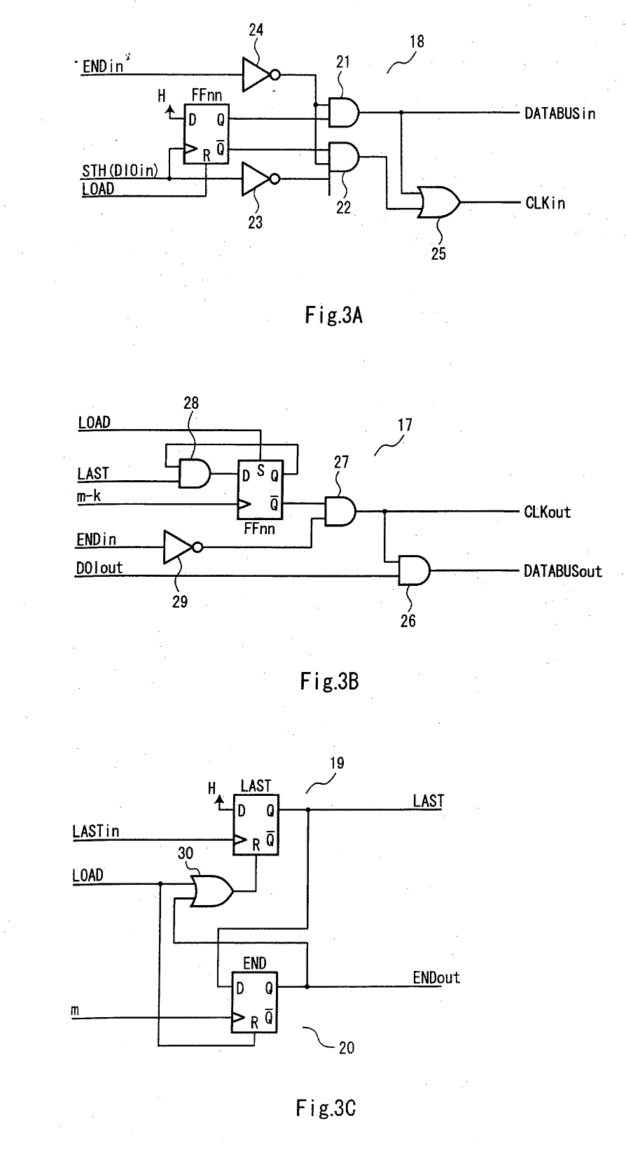

As shown in FIG. 3A, 1st control part 17 includes AND circuits 21 and 22, inverters 23 and 24, OR circuit 25, and D-flip-flop FFnn. Q of D-flip-flop FFnn is reset to low level (L) when load signal LOAD is inputted (when load signal LOA is high level (H)). Q is set to high level when start pulse signal STH or data take-in signal DOI inputted from the preceding source driver is inputted to a DIO terminal (when these signals STH and DOI are high level).

As shown in FIG. 5 (a), when load signal LOAD is inputted to D-flip-flop FF11, D-flip-flop FF11 is set to low level in 1st control part 17 of source driver IC1. When start pulse signal STH is low level, control signal CLKin is set to high level. Then clock input circuit 2 starts to drive by control signal CLKin. Clock input circuits 2 of source drivers IC2-ICn start to drive since D-flip-flop FFnn holds low level when the falling signal of data take-in signal DOI is inputted to each DIO terminal (when data take-in signal DOI is set to low level). When control signal ENDin is inputted from source driver ICn of the last stage, clock input circuits 2 of all source drivers IC1-ICn will stop drive.

When start pulse signal STH or data take-in signal DOI from the preceding source driver is inputted to DIO terminal (when signals STH and DOI are high level), source drivers IC1-ICn output control signal DATABUSin (control signal DATABUSin is high level), and pixel data input circuit 9 starts to drive. When control signal ENDin is inputted from source driver ICn of the last stage to source drivers IC1-ICn, pixel data input circuit 9 of all source drivers IC1-ICn will stop drive.

As shown in FIG. 3B, 2nd control part 18 includes AND circuits 26, 27, and 28, inverter 29, and D flip-flop FFn. As shown in FIG. 5B and FIG. 5C, Q of D flip-flop FFn is set to high level when the load signal LOAD is inputted (when load signal LOAD is high level). Q is set to low level, when control signal LAST is low level and shift register 4 of the number m-k (k>2) outputs shift clock SRm-k, i.e., when clock signal m-k is inputted. When control signal LAST is high level and clock signal m-k is inputted, control signal LAST holds the value of Q.

As mentioned above, as shown in FIG. 5B and FIG. 5C, when clock signal m-k is inputted, Q of D flip-flop FFn is set to low level, and control signal ENDin is low level, CLKout outputs high level and clock output circuit 3 starts to drive. Since CLKout outputs high level when Q is low level and control signal ENDin is low level, clock output circuit 3 is driving. When control signal ENDin is inputted from source driver ICn of the last stage to source drivers IC1-ICn, CLKout will output low level and clock output circuit 3 of all source drivers IC1-ICn will stop drive.

As shown in FIG. 5C, when Q of D flip-flop FFn is set to low level and control signal ENDin is low level, and when DOIout is high level, DATABUSout outputs high level. Pixel data output circuit 10 starts to drive. When control signal ENDin is inputted from source driver ICn of the last stage to source drivers IC1-ICn, pixel data output circuits 10 of all source drivers IC1-ICn will stop drive.

As shown in FIG. 3C, 3rd control part 19 and 20 includes OR circuit 30, D-flip-flop LAST, and D-flip-flop END. D flip-flop LAST is reset to low level when load signal LOAD or control signal ENDout is inputted. D flip-flop LAST is reset to high level when data take-in signal DOI (LASTin) is outputted from preceding source driver ICn-1 of the last stage input to D flip-flop LAST. When control signal LAST is high level and clock signal m of source driver ICn of the last stage is inputted, D-flip-flop END is set to high level. That is, as shown in FIG. 3A and FIG. 5A, control signals CLKin and DATABUSin are set to low level by inputting control signal ENDout (ENDin) to source driver IC1-ICn-1 from source driver ICn of the last stage, and clock input circuit 2 and pixel data input circuit 9 will stop to drive. As shown in FIG. 3B, when 2nd control part 18 of source driver ICn of the last stage, from which control signal LAST is generated, is set to high level by load signal LOAD, control signals CLKout and DATABUSout are set to low level by inputting clock signal m-k, and clock output circuit 3 and pixel data output circuit 10 of source driver ICn of the last stage will stop drive.

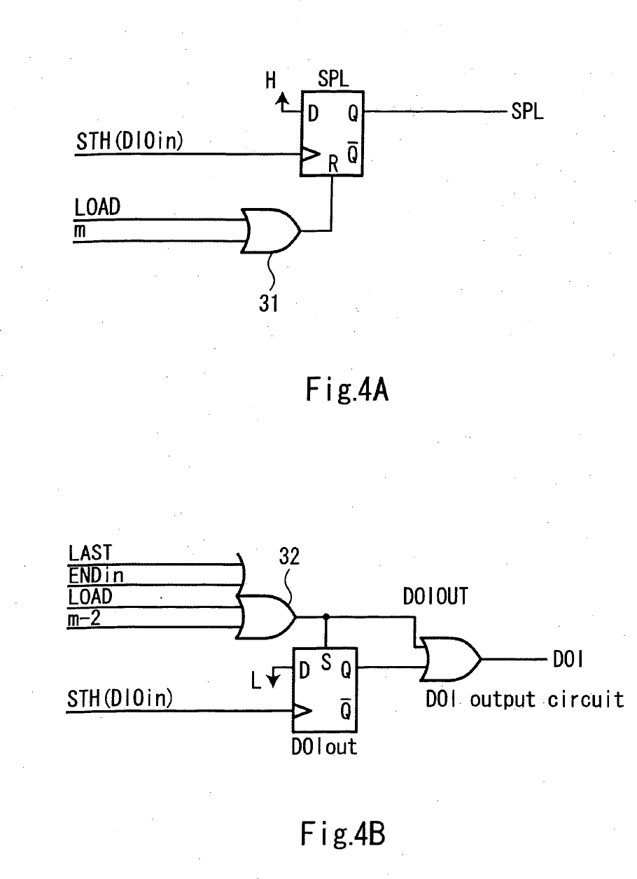

As shown in FIG. 4A, SPL circuit 16 includes OR circuit 31 and D-flip-flop SPL. Q of D-flip-flop SPL is reset to low level, when load signal LOAD or clock signal m is inputted. The Q is set to high level, when start pulse signal STH or data take-in signal DOI outputted from the preceding source driver is inputted to D-flip-flop SPL (when these signal STH or DOI is high level). That is, as shown in FIG. 6A, when start pulse signal STH or data take-in signal DOI from preceding source driver is inputted, control signal SPL is outputted high level, and shift register 4 and buffers 14 and 15 will activate. SPL circuit latches the corresponding digital pixel data of a source driver. When load signal LOAD or clock signal m is inputted to SPL circuit 16, control signal SPL outputs low level, and SPL circuit does not latch the corresponding digital pixel data of a source driver.

As shown in FIG. 4B, DOI generation circuit 13 includes OR circuit 32, DOI output circuit 12 having OR circuit, and D-flip-flop circuit DOIout. Q of D-flip-flop circuit DOIout is set to low level, when clock signal m-k is inputted to D-flip-flop circuit DOIout, i.e., when shift register 4 of the number m-k outputs shift clock SRm-k. When load signal LOAD, clock signal m-2, control signal LAST, or control signal ENDin outputted from source driver ICn of the last stage are inputted to D-flip-flop circuit DOIout, the Q is set to high level. That is, data take-in signal DOI outputted by DOI generation circuit 13 is set to high level, when load signal is inputted. When clock signal m-k is inputted, data take-in signal DOI is set to low level. When clock signal m-2, control signals LAST, and END are inputted, data take-in signal DOI is set to high level.

As shown in FIG. 6B, when load signal LOAD, clock signal m-2, control signal LAST, or control signal ENDin from source driver ICn of the last stage is inputted, control signals DOIOUT and DOIout are set to high level. Then, DOI output circuit 12 stops to drive. When clock signal m-k is high level, and load signal LOAD, clock signal m-2, control signal LAST, or control signal ENDin outputted from source driver ICn of the last stage is low level, DOI output circuit 12 starts to drive.

As mentioned above, control circuit 11 can control each input circuit and output circuit.

Here, circuit configurations of control part 17-20, SPL circuit 16, and DOI generation circuit 13 in FIG. 3 and FIG. 4 are for realizing truth value tables of FIG. 5 and FIG. 6, and especially circuit configurations are changeable according to the truth value tables.

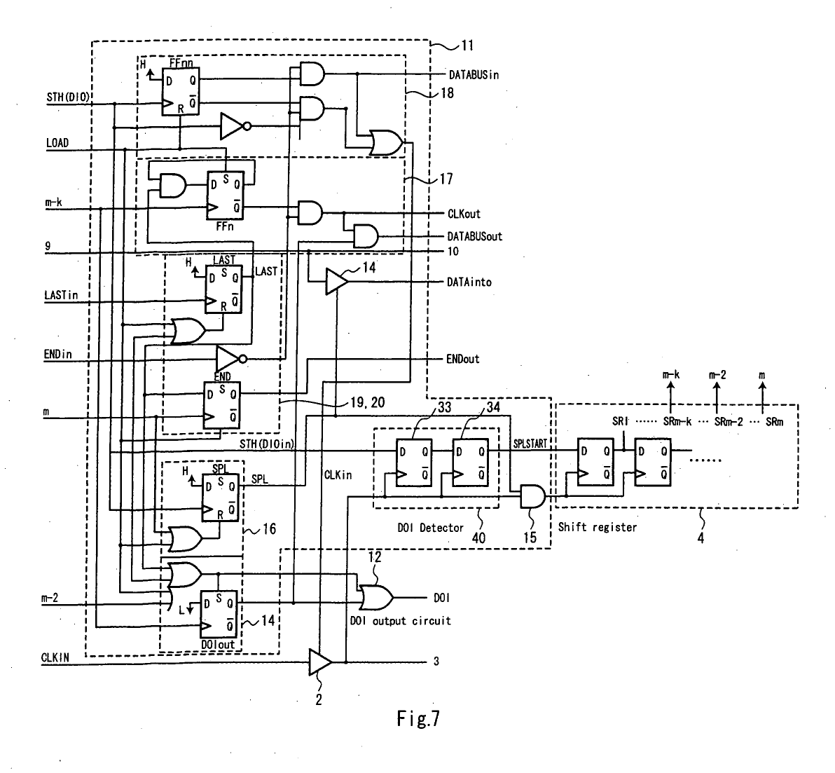

As shown in FIG. 7, control circuit 11 has 1st control part 17, 2nd control part 18, 3rd control part 19 and 20, SPL circuit 16, DOI generation circuit 13, and DIO detector. As these circuits have the same circuit configuration as shown in FIG. 3 and FIG. 4, description of 1st control part 17, 2nd control part 18, and 3rd control part 19 and 20 is omitted.

DIO detector has D flip-flops 33 and 34 by which cascade connection is carried out. D flip-flops 33 and 34 operate synchronized to the clock signal passed through clock input circuit 2. Output signal SPLSTART of DIO detector is inputted to shift register 4. Shift register 4 operates in synchronization with the output signal (CLKinto) of buffer 15 (AND circuit) which performs an AND of clock signal and control signal SPL.

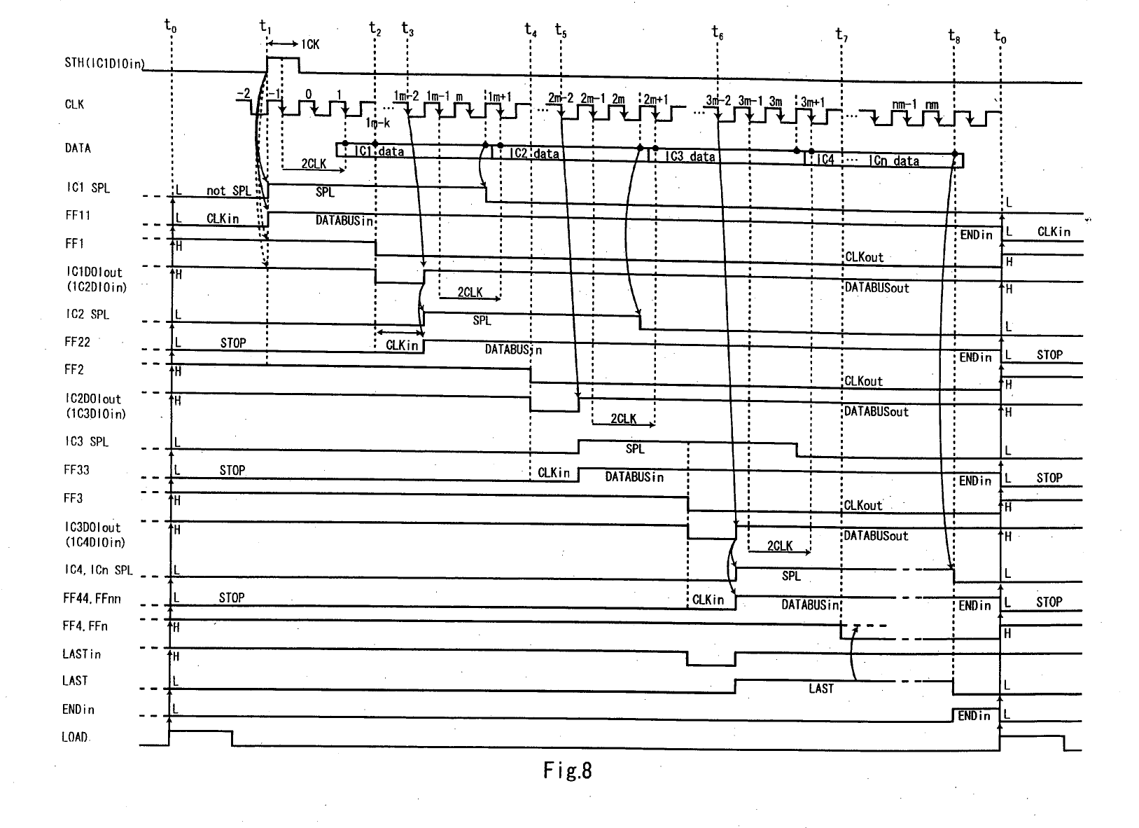

Hereafter, operation of signal-line drive circuit of FIG. 1 is explained using FIG. 8.

As shown in FIG. 8, before start pulse signal STH is inputted, load signal LOAD is inputted (time t0). CLKin is inputted to clock input circuit 2 of the source driver IC1, and clock input circuit 2 starts to drive. Since DIO terminal of source drivers IC2-ICn is high level at time t0, clock input circuits 2 of source drivers IC2-ICn are inoperative. Signal-line drive circuit generates no power consumption by clock input circuits 2 of source drivers IC2-ICn. The drive of a signal line is started by inputting start pulse signal STH to DIO terminal of source driver IC1 (time t1).

Here, clock input circuit 2 may start to drive by the time start pulse signal STH of time t1 is inputted.

When start pulse signal STH is inputted to DIO terminal of source driver IC1 at time t1, D-flip-flop FF11 of source driver IC1 is set to high level, DATABUSin outputs high level, and pixel data input circuit 9 starts to drive. Since DIO terminals of source drivers IC2-ICn are high level at time t1, D-flip-flops FF11 of source drivers IC2-ICn are still low level. Pixel data input circuit 9 does not consume power while inoperative.

By inputting start pulse signal STH to DIO terminal of source driver IC1 at time t1, SPL circuit 16 outputs control signal SPL (becoming high level), and source driver IC1 starts to latch digital pixel data.

Here, pixel data input circuit 3 may start to drive by the time start pulse signal STH of time t1 is inputted.

At time t2, when source driver IC1 outputs shift clock SRm-k of the number m-k, i.e., when clock signal m-k is inputted, D-flip-flop FF1 of source driver IC1 is set to low level, CLKout outputs high level, and clock output circuit 3 starts to drive. Since clock output circuit 3 of source drivers IC2-ICn does not start at this time, power is not consumed by clock output circuit 3 of source drivers IC2-ICn.

DOI terminal of source driver IC1, i.e., DIO terminal of source driver IC2, is set to low level at time t2. When the DIO terminal of source driver IC2 is set to low level, CLKin is inputted to clock input circuit 2 of source driver IC2, and clock input circuit 2 of source driver IC2 starts to drive. Since clock input circuit 2 of source drivers IC3-ICn is not started at this time, power consumption is not consumed by clock input circuit 2 of source drivers IC3-ICn.

Here, clock output circuit 3 of the source driver IC1 and clock input circuit 2 of source driver IC2 may start to drive by the time source driver IC 2 start to latch at time t3. These circuits may not start to drive at the same timing.

At time t3, when source driver IC 1 outputs shift clock SRm-2 of the number m-2, i.e., when clock signal m-2 are inputted, DOI terminal of source driver IC1, i.e., DIO terminal of source driver IC2, becomes high level. At this time, DATABUSout is outputted from control circuit 11 of source driver IC1, and pixel data output circuit 10 of source driver IC1 starts to drive. Since pixel data output circuit 10 of source drivers IC2-ICn does not start to drive at this time, power is not consumed by pixel data output circuit 10 of source drivers IC2-ICn.

At time t3, since DIO terminal of source driver IC2 becomes high level, D-flip-flop FF22 of source drivers IC 1 is set to high level, DATABUSin outputs high level, and pixel data input circuit 9 of source driver IC2 starts to drive. Since DIO terminal of source drivers IC3-ICn is high level at this time, D-flip-flop FFnn of source drivers IC3-ICn is still low level and pixel data input circuit 9 does not consume power while inoperative.

At time t3, since DIO terminal of source driver IC2 is high level, SPL circuit 16 of source driver IC2 outputs control signal SPL (becoming high level), and source driver IC2 starts to latch digital pixel data.

Here, pixel data output circuit 10 of source driver IC1 and pixel data input circuit 9 of source driver IC2 may start to drive by the time source driver IC2 starts to latch at time t3. These circuits may not start to drive at the same timing.

At time t4 as well as time t2, when source driver IC2 outputs shift clock SRm-k of the number m-k, i.e., when clock signal m-k source driver IC2 is inputted, clock output circuit 3 of source driver IC2 and clock input circuit 2 of source driver IC3 start to drive.

At time t5 as well as time t3, when source driver IC2 outputs shift clock SRm-2 of the number m-2, i.e., when clock signal m-2 is inputted, pixel data input circuit 9 of source driver IC3 and pixel data output circuit 10 of source driver IC2 start to drive. Source driver IC 3 starts to latch digital pixel data.

As described above, the same start operation is repeatedly performed to source driver ICn-1, clock input circuit 2, clock output circuit 3, pixel data input circuit 9, and pixel data output circuit 10 of source driver IC1-ICn-1 one by one. That is, since these circuits start to drive just before source driver itself starts to latch pixel data, power consumption is reduced.

Next, at time t6, when source driver ICn-1 outputs shift clock SRm-2 of the number m-2, i.e., when clock signal m-2 is inputted, pixel data output circuit 10 of source driver ICn-1 and pixel data input circuit 9 of source driver ICn start to drive like at the above-mentioned time t2. Source driver ICn starts to latch digital pixel data.

Then, as shown in FIG. 1, signal of DOI terminal of source driver ICn-1 is set to high level, and is inputted to source driver ICn as control signal LASTin. Since DOI terminal of source driver ICn-1 is set to high level from low level at time t6, D-flip-flop LAST is set to high level.

At time t7, when source driver ICn outputs shift clock SRm-k, that is, when clock signal m-k is inputted to source driver ICn, D flip-flop FFn of source driver ICn holds the high level in order that D-flip-flop LAST is at high level. Since CLKout holds low level, clock output circuit 3 of source driver ICn does not start to drive.

Between time t7 and time t8, when source driver ICn outputs shift clock SRm-2, that is, when clock signal m-2 is inputted to source driver ICn, D flip-flop FFn of source driver ICn holds high level since D-flip-flop LAST is high level. Since DATABUSout holds low level, pixel data output circuit 10 of source driver ICn does not start to drive.

Since control signal LAST is high level, DOI output circuit 12 of source driver ICn does not start to drive, either.

As mentioned above, it is not necessary to start to drive clock output circuit 3, pixel data output circuit 10, and DOI output circuit 12 of source driver ICn, and power consumption is not reduced.

Then, at time t8, when last shift clock SRm of source driver ICn is outputted, i.e., when clock signal m is outputted, all source drivers IC1-ICn end to latch digital pixel data. Then, when clock signal m is inputted to source driver ICn, D-flip-flop END of source driver ICn outputs high level, and control signal ENDin is outputted to source driver IC1-ICn-1. Control signals CLKin, CLKout, DATABUSin, DATABUSout, and DOIOUT of source driver IC1-ICn-1 output low level, and clock input circuit, clock output circuit, pixel data input circuit, pixel data output circuit, and DOI generation circuit 13 stop to drive. Then, drive at time t0 is repeated.

After all digital pixel data is latched, digital pixel data is changed to analog data by D/A converter (D/A) 7 by inputting load signal LOAD at time t0, and is outputted to signal line from output circuit. Pixel data is displayed by the liquid crystal display.

As mentioned above, the liquid crystal drive device according to a first embodiment of this invention can reduce the power consumption of source drivers IC1-ICn by reducing driving time of source drivers IC1-ICn drive. Moreover, since the power consumption of source drivers IC1-ICn can be reduced, unnecessary EMI can be reduced.

In addition, this invention is not at all limited to the embodiment above described in detail, and this invention can change variously within the main point of this invention. For example, it is applicable to other plane display, such as EL (Electroluminescence) display, too.

While the invention is subject to various modifications and alternative forms, specific embodiments thereof are shown by way of embodiment in the drawings and the accompanying detailed description. It should be understood that the drawings and detailed description are not intended to limit the invention to the particular embodiments which are described. This disclosure is instead intended to cover all modifications, equivalents and alternatives falling within the scope of the present invention as defined by the appended claims.

1. A display drive device, comprising:
a plurality of cascade connected source drivers, each source driver comprising,
a pixel data input circuit for receiving and outputting a pixel data,
a clock input circuit for receiving a clock signal for latching a pixel data outputted from the pixel data input circuit,
a latch circuit for latching the pixel data outputted from the pixel data input circuit in synchronization with the clock signal,
a data output circuit for outputting the pixel data inputted to the clock input circuit,
a clock output circuit outputting the clock signal inputted to the clock input circuit,
a generation circuit generating a data take-in signal for instructing the source driver to start to drive, and
a detector for latching a start pulse signal providing a display timing or the data take-in signal outputted from the generation circuit in synchronization with the clock signal; and
a controller for controlling start of drive of the clock input circuit or the pixel data input circuit of the first cascade connected source driver by the time the start pulse signal is inputted, the controller starting to drive the clock input circuit or the pixel data input circuit of a source driver other than the first source driver by the time the data take-in signal is inputted to the source driver other than the first source driver from a time when the first source driver starts to latch the pixel data.

2. A display drive device according to claim 1, wherein the controller starts to drive the clock output circuit or the pixel data output circuit by the time the data take-in signal is outputted from the generation circuit from a time when the first source driver starts to latch the pixel data.

3. A display drive device according to claim 1, wherein the controller outputs a control signal to the clock output circuit or the pixel data output circuit of the last source driver, the control signal controlling not to start to drive the clock output circuit or the pixel data output circuit of the last source driver.

4. A display drive device according to claim 1, wherein the controller controls to stop to drive of at least the clock input circuit, the clock output circuit, the pixel data input circuit, and the pixel data output circuit when the last source driver finishes latching the pixel data.

5. A display drive device, comprising:
a plurality of cascade connected source drivers, each source driver comprising,
a pixel data input circuit for receiving and outputting a pixel data,
a clock input circuit for receiving a clock signal for latching a pixel data outputted from the pixel data input circuit,
a latch circuit for latching the pixel data outputted from the pixel data input circuit in synchronization with the clock signal,
a data output circuit for outputting the pixel data inputted to the clock input circuit,
a clock output circuit outputting the clock signal inputted to the clock input circuit,
a generation circuit generating a data take-in signal for instructing the source driver to start to drive, and
a detector for latching a start pulse signal providing a display timing or the data take-in signal outputted from the generation circuit in synchronization with the clock signal; and
a controller for controlling start of drive of the clock output circuit or the pixel data output circuit of the first source driver by the time the data take-in signal is outputted from the generation circuit from a time when the first source driver starts to latch the pixel data.

6. A display drive device according to claim 5, wherein the controller outputs a control signal to the clock output circuit or the pixel data output circuit of the last source driver, the control signal controlling not to start to drive the clock output circuit or the pixel data output circuit of the last source driver.

7. A display drive device according to claim 5, wherein the controller controls to stop to drive at least the clock input circuit, the clock output circuit, the pixel data input circuit, and the pixel data output circuit when the last source driver finishes latching the pixel data.

8. A liquid crystal display device, comprising:
a liquid crystal display; and
a plurality of cascade connected source drivers coupled to the liquid crystal display, each source driver comprising,
a pixel data input circuit for receiving and outputting a pixel data,
a clock input circuit for receiving a clock signal for latching a pixel data outputted from the pixel data input circuit,
a latch circuit for latching the pixel data outputted from the pixel data input circuit in synchronization with the clock signal,
a data output circuit for outputting the pixel data inputted to the clock input circuit,
a clock output circuit outputting the clock signal inputted to the clock input circuit,
a generation circuit generating a data take-in signal instructing the source driver to start to drive, and
a detector for latching a start pulse signal providing a display timing or the data take-in signal outputted from the generation circuit in synchronization with the clock signal; and
a controller for controlling start of drive of the clock input circuit or the pixel data input circuit of the first cascade connected source driver by the time the start pulse signal is inputted, the controller starting to drive the clock input circuit or the pixel data input circuit of a source driver other than the first source driver by the time the data take-in signal is inputted to the source driver other than the first source driver from a time when the first source driver starts to latch the pixel data.

9. A liquid crystal display device according to claim 8, wherein the controller starts to drive the clock output circuit or the pixel data output circuit of the first source driver by the time the data take-in signal is outputted from the generation circuit from a time when the first source driver starts to latch the pixel data.

10. A liquid crystal display device according to claim 8, wherein the controller outputs a control signal to the clock output circuit or the pixel data output circuit of the last source driver, the control signal controlling not to start to drive the clock output circuit or the pixel data output circuit of the last source driver.

11. A liquid crystal display device according to claim 8, wherein the controller controls to stop to drive at least the clock input circuit, the clock output circuit, the pixel data input circuit, and the pixel data output circuit of the last source driver when the last source driver finishes latching the pixel data.

12. A liquid crystal display device, comprising:
a liquid crystal display; and
a plurality of cascade connected source drivers coupled to the liquid crystal display, the source drivers comprising,
a pixel data input circuit for receiving and outputting a pixel data,
a clock input circuit for receiving a clock signal for latching a pixel data outputted from the pixel data input circuit,
a latch circuit for latching the pixel data outputted from the pixel data input circuit in synchronization with the clock signal,
a data output circuit for outputting the pixel data inputted to the clock input circuit,
a clock output circuit outputting the clock signal inputted to the clock input circuit,
a generation circuit generating a data take-in signal instructing the source driver to start to drive, and
a detector for latching a start pulse signal providing a display timing or the data take-in signal outputted from the generation circuit in synchronization with the clock signal; and
a controller for controlling start of drive of the clock output circuit or the pixel data output circuit of the first source driver by the time the data take-in signal is outputted from the generation circuit from a time when the first source driver starts to latch the pixel data.

13. A liquid crystal display device according to claim 12, wherein the controller outputs a control signal to the clock output circuit or the pixel data output circuit of the last source driver, the control signal controlling not to start to drive the clock output circuit or the pixel data output circuit of the last source driver.

14. A liquid crystal display device according to claim 12, wherein the controller controls to stop to drive at least the clock input circuit, the clock output circuit, the pixel data input circuit, and the pixel data output circuit of the last source driver when the last source driver finishes latching the pixel data.

15. A liquid crystal drive device according to claim 2, wherein the controller outputs a control signal to the clock output circuit or the pixel data output circuit of the last source driver, the control signal controlling not to start to drive the clock output circuit or the pixel data output circuit of the last source driver.

16. A liquid crystal drive device according to claim 15, wherein the controller controls to stop to drive at least the clock input circuit, the clock output circuit, the pixel data input circuit, and the pixel data output circuit of the last source driver when the last source driver finishes latching the pixel data.

17. A liquid crystal display device according to claim 9, wherein the controller outputs a control signal to the clock output circuit or the pixel data output circuit of the last source driver, the control signal controlling not to start to drive the clock output circuit or the pixel data output circuit of the last source driver.

18. A liquid crystal display device according to claim 17, wherein the controller controls to stop to drive at least the clock input circuit, the clock output circuit, the pixel data input circuit, and the pixel data output circuit of the last source driver when the last source driver finishes latching the pixel data.

19. A liquid crystal drive device according to claim 16, wherein the controller includes a plurality of latch circuits.

20. A liquid crystal display device according to claim 16, wherein the controller includes a plurality of latch circuits.
